(19) United States
(12) Patent Application Publication
(10) Pub. No.: US 2015/0149623 A1
(43) Pub. Date: May 28, 2015

(54) MANAGEMENT SYSTEM AND METHOD FOR CONTROLLING THE SAME

(71) Applicant: CANON KABUSHIKI KAISHA, Tokyo (JP)

(72) Inventor: Masahito Numata, Kawasaki-shi (JP)

(21) Appl. No.: 14/552,272

(22) Filed: Nov. 24, 2014

(30) Foreign Application Priority Data
Nov. 27, 2013 (JP) 2013-244898

(51) Int. Cl. H04L 12/26; H04L 29/08

(52) U.S. Cl. CPC H04L 43/04; H04L 67/16
USPC 709/224

(57) ABSTRACT

A management system configured to collect operational information of network devices provided on a plurality of local networks includes a first management unit configured to separately manage the collected operational information in a plurality of tenants to which different access rights are set, a second management unit configured to tally and manage in group units a part of the operational information of the plurality of tenants managed separately by the first management unit, and a providing unit configured to provide the tallied operational information managed by the second management unit, wherein the second management unit manages the tallied operational information so as to hide or exclude a part of the tallied operational information.

### BACKGROUND

1. Field

Aspects of the present invention generally relate to a management system configured to manage devices and a method for controlling the same.

2. Description of the Related Art

In recent years, methods by which an outsourced device management service including device management of network devices such as image forming apparatuses (copying machines, printers, etc.) of a customer, failure recovery, suggestion for improvement of the printing status, etc. is realized as a cloud service using a server on the Internet, have been known. In the device management service, a service provider needs to display on a web user interface (web UI) the operational status of a customer to which the service is provided, in order to check and monitor the status. The service provider also needs to display a list of information about a plurality of customers on a single web UI to check whether there is any customer having a problem and/or to compare the operational status of a specific customer with those of the other customers.

In a cloud service, it is common to separate customer data and manage the customer data in a multi-tenant configuration. However, the multi-tenant configuration has a problem that it takes time to acquire the data of a plurality of customers, since in the multi-tenant configuration it is not possible to access data of a plurality of customers by one-time query. Thus, a high user-experience display method is necessary in which customers are sequentially displayed in descending order according to the necessity for a service provider to see.

Japanese Patent Application Laid-Open No. 2011-215862 discusses a technique in which a user prioritizes categories of information in advance to determine a display order, and then categories of information distributed from a server are identified to sequentially display the information in descending order according to priority.

However, according to the technique discussed in Japanese Patent Application Laid-Open No. 2011-215862, the categories of information and the priority order are fixed, and thus it is not possible to dynamically change the priority order according to a situation. When the operational statuses are checked in the device management service, the priority order of information varies depending on the situation. For example, in a case where there are two customers both having an operational value lower than a target value, the problem is more critical for one customer having the operational value lower than the target value after a sufficient tallying period than for the other customer that already had a lower operational value than the target value at the beginning of tallying. Further, in a case where a plurality of customers are in the same operational status, higher priority may be given to the customer with a higher degree of attention since the customer pays a higher fee, etc. Thus, even if the technique discussed in Japanese Patent Application Laid-Open No. 2011-215862 is applied to a device management service, the device management service cannot display information of customers in an appropriate priority order.

Further, as described above, in a device management service, it is common to separate data of customers for each tenant to securely manage the data. To determine the display priority order of customer information, it is necessary to compare information of a plurality of customers in a single storage unit. In view of security and information protection, however, it is not desirable to compare pieces of information, which are separated for each tenant and securely managed, in a single storage area where the pieces of information are not securely separated.

### SUMMARY

Aspects of the present invention are generally directed to a management system and a method for controlling the same capable of sequentially displaying information of customers in descending order of the necessity for a user (service provider, e.g., operator or serviceperson of sales company) to see according to a situation, thereby securely providing displays with high user-experience.

According to an aspect of the present invention, a management system configured to collect operational information of network devices provided on a plurality of local networks includes, a first management unit configured to separately manage the collected operational information in a plurality of tenants to which different access rights are set, a second management unit configured to tally and manage in group units a part of the operational information of the plurality of tenants managed separately by the first management unit, and a providing unit configured to provide the tallied operational information managed by the second management unit, wherein the second management unit manages the tallied operational information so as to hide or exclude a part of the tallied operational information.

Further features of the present disclosure will become apparent from the following description of exemplary embodiments with reference to the attached drawings.

### BRIEF DESCRIPTION OF THE DRAWINGS

FIG. 1 illustrates an example of a configuration of a device management system according to an exemplary embodiment.

FIG. 2 illustrates an example of a hardware configuration of an image forming apparatus.

FIG. 3 illustrates an example of a hardware configuration of a device management server, etc.

FIG. 4 illustrates an example of a software configuration of a device management system.

FIG. 5 illustrates an example of a data configuration of operator attention information.

FIG. 6 illustrates an example of a data configuration of device information representative data.

FIG. 7 illustrates an example of a list screen of operational statuses of respective customers.

FIG. 8 illustrates an example of a comparison display screen of focused customers.

FIG. 9 is a sequence diagram of a list screen of operational statuses of respective customers displayed using scripts.

FIG. 10 is a sequence diagram of a list screen of operational statuses of respective customers displayed with push transmission.

FIG. 11 is a flow chart illustrating a process executed by a device management server to determine a display priority order.

### DESCRIPTION OF THE EMBODIMENTS

Various exemplary embodiments will be described in detail below with reference to the drawings.

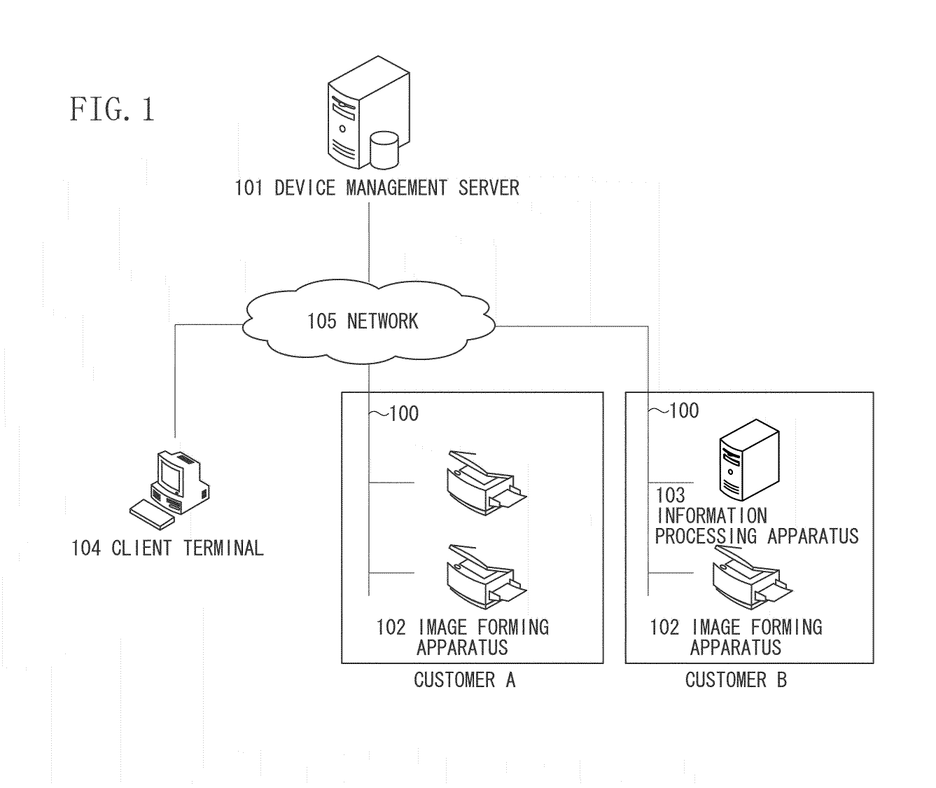

Devices included in a device management system according to a first exemplary embodiment will be described below with reference to FIG. 1.

FIG. 1 illustrates an example of a configuration of the device management system according to the present exemplary embodiment.

As illustrated in FIG. 1, in the device management system according to the present exemplary embodiment, a device management server 101, image forming apparatuses 102, an information processing apparatus 103, and a client terminal 104 are connected with each other via a network 105.

In the present exemplary embodiment, the device management system manages the image forming apparatuses 102 by grouping the image forming apparatuses 102 in customer units (e.g., customer A, customer B) or tenants to be managed by the management system (details thereof will be described below). The unit of grouping is not limited to the customers and may be organizations, locations, and the like.

In an environment of the customer A, the image forming apparatuses 102 capable of directly communicating with the device management server 101 are set. In an environment of the customer B, the image forming apparatus 102, which is not capable of directly communicating with the device management server 101, is connected to the device management server 101 via the information processing apparatus 103.

The client terminal 104 is not limited to a personal computer and may be an image forming apparatus, a mobile terminal, or the like having similar functions. A network 100 and the network 105 are communication lines for sending or receiving information between the foregoing devices. The networks 100 and 105 may be the Internet or intranet and may be a wired or wireless communication line.

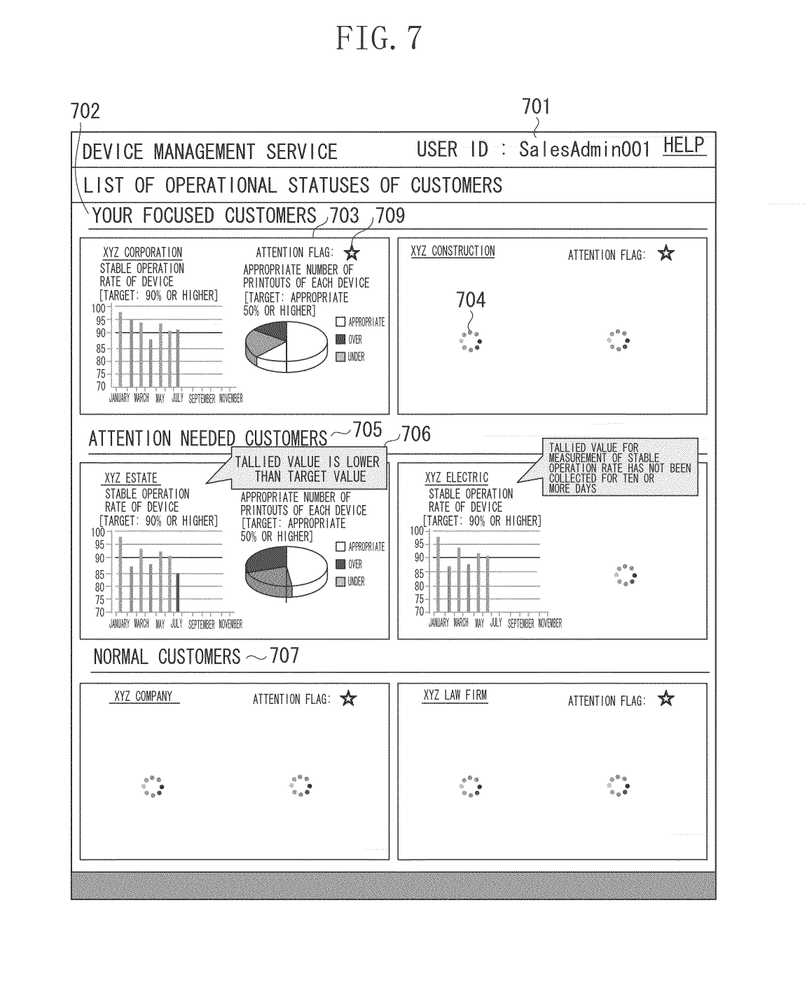

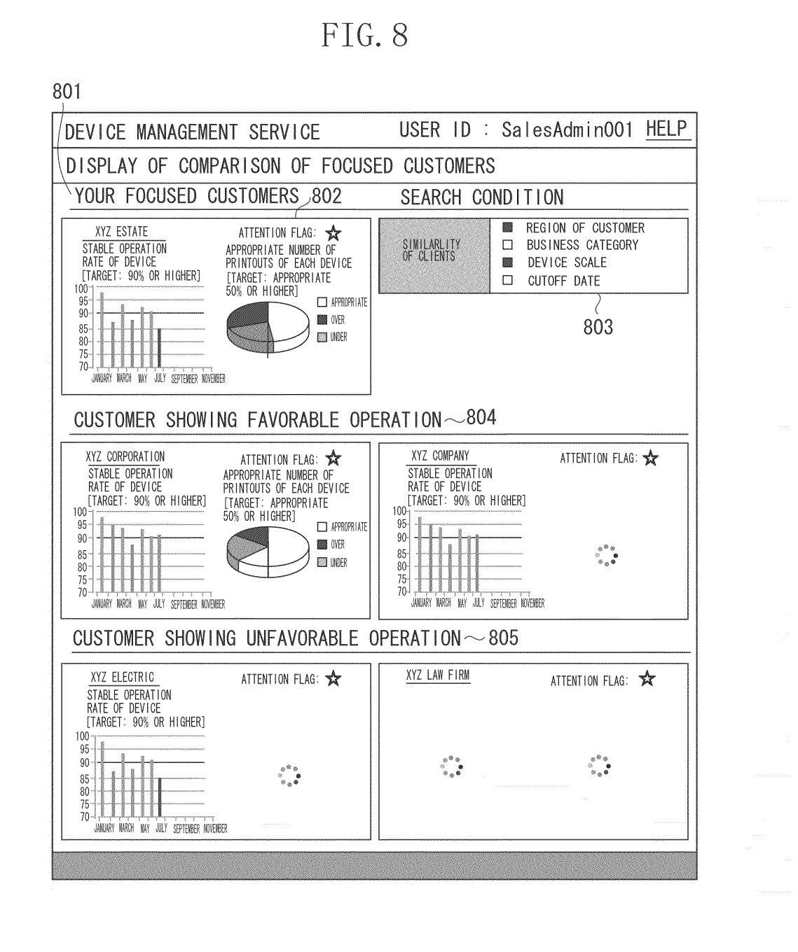

The device management server 101 is a management system configured to collect operational information of network devices (image forming apparatuses 102 in the example illustrated in FIG. 1) placed on a plurality of local networks. The device management server 101 includes one or more servers. In the present exemplary embodiment, the device management server 101 has functions of accumulating and reporting operational information of the network devices (image forming apparatuses 102) such as log information and failure information that is collected from the local networks 100 of the respective customers. For example, a check screen that timely shows only the device operational statuses and operational statuses of specific customers as illustrated in FIGS. 7 and 8 described below is displayed on the client terminal 104 as a reporting function. This function is provided for, for example, operators or servicemen of sales companies.

In the present exemplary embodiment, while the image forming apparatuses such as printers and copying machines are described as examples of the network devices managed by the device management server 101, the network devices are not limited to the image forming apparatuses.

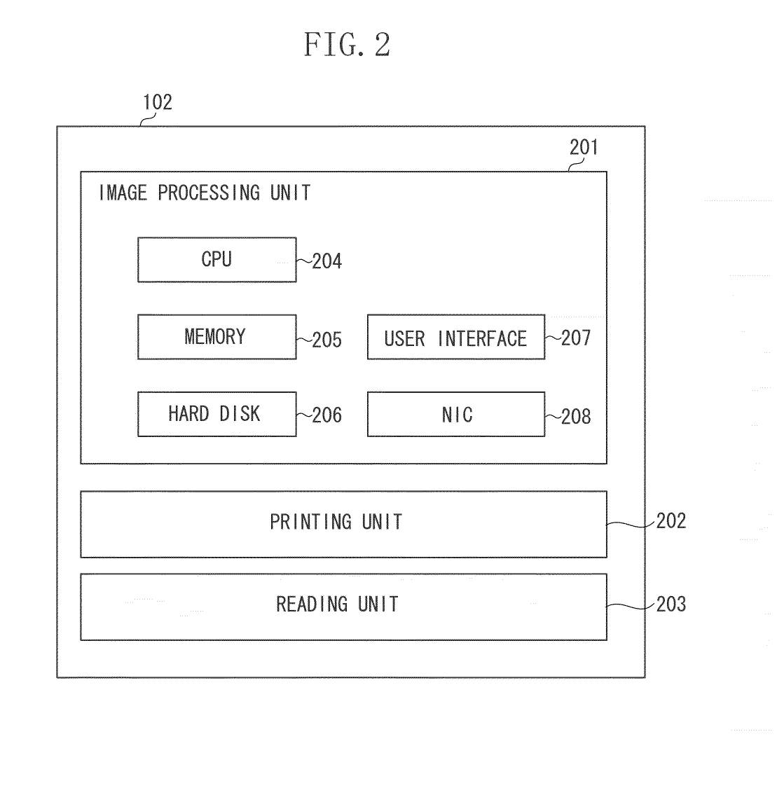

Next, the hardware configurations of the devices included in the device management system will be described. FIG. 2 illustrates an example of a hardware configuration of the image forming apparatus 102.

As illustrated in FIG. 2, the image forming apparatus 102 includes an image processing unit 201, a printing unit 202, and a reading unit 203. In a case where the image forming apparatus 102 is not a multifunctional peripheral, the reading unit 203 may be omitted.

The image processing unit 201 includes a central processing unit (CPU) 204, a memory 205, a hard disk 206, and a user interface 207. The CPU 204 is a unit configured to execute various types of programs to realize various functions. The memory 205 is a unit configured to temporarily store various types of information. The CPU 204 loads programs stored in the hard disk 206 into the memory 205 and executes the programs. The memory 205 is also used as a temporary working storage area of the CPU 204.

The hard disk 206 is a unit configured to store various types of data. The hard disk 206 may be any other hardware such as a flash memory having similar functions. The user interface 207 is a unit configured to receive a processing request from a user and output a screen to the user.

A network interface card (NIC) 208 is a unit configured to connect the image forming apparatuses 102 to the network 100, etc. The example illustrated in FIG. 2 is a mere typical hardware configuration of an image forming apparatus, and the configurations of the image forming apparatuses 102 are not limited to that illustrated in FIG. 2. For example, the image forming apparatuses 102 may be connected to a fax board or an external control apparatus.

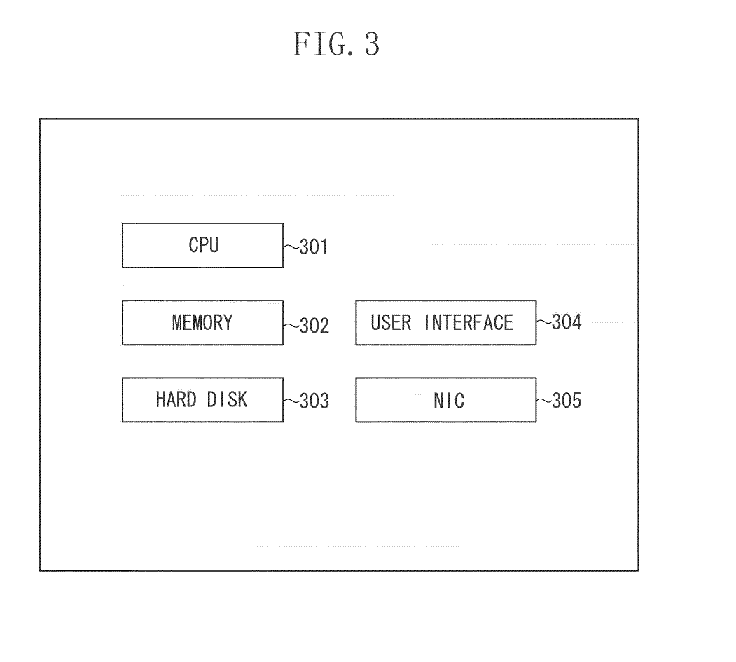

FIG. 3 illustrates an example of hardware configurations of the device management server 101, the information processing apparatus 103, and the client terminal 104.

In FIG. 3, a CPU 301 is a unit configured to execute various programs to realize various functions. A memory 302 is a unit configured to temporarily store various types of information. The CPU 301 loads programs stored in a hard disk 303 into the memory 302 and executes the programs. The memory 302 is also used as a temporarily working storage area of the CPU 301.

The hard disk 303 is a unit configured to store various types of data. The hard disk 303 may be any other hardware such as a flash memory having similar functions. A user interface 304 is a unit configured to receive a processing request from a user and output a screen to the user.

A NIC 305 is a unit configured to connect the device management server 101 and the client terminal 104 to the networks. The device management server 101 and the client terminal 104 can be connected to the networks 100 and 105 by using the NIC 305.

The example illustrated in FIG. 3 is a mere typical hardware configuration of the device management server 101, the information processing apparatus 103, and the client terminal 104, and the configurations of the device management server 101, the information processing apparatus 103, and the client terminal 104 are not limited to that illustrated in FIG. 3. The device management server 101 may be a system including one or more servers.

A software configuration of the device management system will be described below.

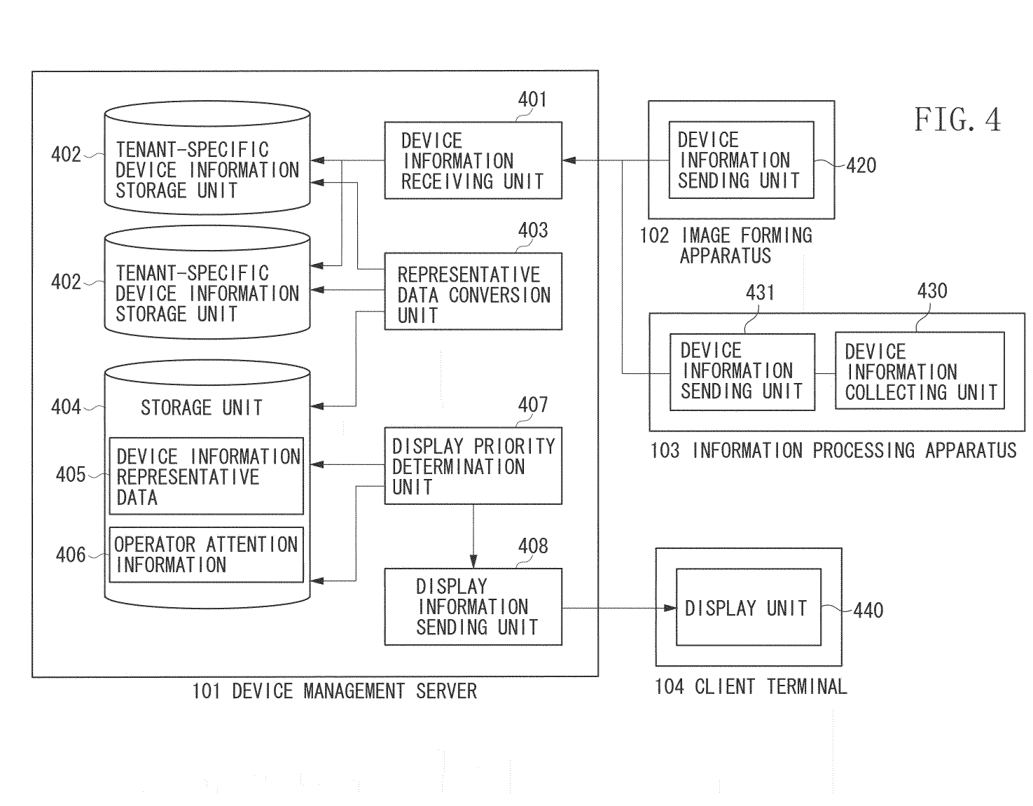

FIG. 4 illustrates an example of the software configuration of each device included in the device management system.

First, the software configuration of the image forming apparatus 102 will be described.

A device information sending unit 420 sends various types of information generated through the use of the image forming apparatus 102 to the device management server 101. Examples of the various types of information generated through the use of the image forming apparatus 102 include job execution history, error occurrence information, operational information, consumables information, settings information, operation history, repair information, query information, etc., and the information are not limited to specific information. Hereinafter, the various types of information will be referred to as device information.

A program for realizing the function of the device information sending unit 420 is stored in the hard disk 206 of the image forming apparatus 102, and the CPU 204 loads the program into the memory 205 and executes the program to realize the function of the device information sending unit 420. Further, an image forming apparatus 102 including no device information sending unit 420 may be included in the device management system (not illustrated in FIG. 4). Device information of the image forming apparatus 102 including no device information sending unit 420 is collected and sent to the device management server 101 by the information processing apparatus 103. Details thereof will be described below.

Next, the software configuration of the information processing apparatus 103 will be described.

A device information collecting unit 430 collects the device information of the image forming apparatus 102 including no device information sending unit 420. Methods and intervals of the collection of the information are not limited. A device information sending unit 431 sends the device information collected by the device information collecting unit 430 to the device management server 101. In this way, the collection and sending of the device information of the image forming apparatus 102 that is not capable of sending the device information to the device management server 101 is possible via the information processing apparatus 103. Programs for realizing the functions of the device information collecting unit 430 and the device information sending unit 431 are stored in the hard disk 303 of the information processing apparatus 103, and the CPU 301 of the information processing apparatus 103 loads the programs into the memory 302 and executes the programs to realize the functions of the device information collecting unit 430 and the device information sending unit 431.

Next, the software configuration of the service management server 101 will be described.

A device information receiving unit 401 receives the device information sent from the image forming apparatus 102 and the device information sent from the information processing apparatus 103. In the device management server 101, information (device information) from a customer having one or more locations is separated in one or more tenants and managed as tenant-specific device information storage units 402. It is also possible to manage information of one customer as one tenant. Different customers always belong to different tenants.

The device information receiving unit 401 uses a means such as authentication to identify the tenant from which the device information is received. Each tenant-specific device information storage unit 402 stores the device information of the specific tenant that is received by the device information receiving unit 401. Since the device information of a tenant contains confidential information and personal information of the tenant, the device information of a tenant is stored separately from the device information of another tenant in view of security and information protection.

The information of each tenant (tenant-specific device information storage unit 402) is managed logically (or physically) separately on a database (DB). Different access rights are set to the respective tenants so that only the operator in charge of a tenant can refer to the information of the tenant. More specifically, an access right is set to tenant-specific device information managed separately in the tenant-specific device information storage unit 402 so that only the operator in charge of a tenant can refer to the tenant-specific device information of the tenant, whereby the tenant-specific device information is protected as secure information. Information indicating customers to which the tenants respectively belong is also stored and managed in the device management server 101 (not illustrated).

Examples of a method for storing tenant-specific device information in tenant units include, but are not limited to, a method using separate databases, a method using separate tables, a method using identifications in a table for discrimination, and a method using different access rights for different tenants.

To prioritize the customers to be displayed on the web UI, it is necessary to compare pieces of device information of a plurality of customers in a single storage unit (e.g., hard disk 303, or memory 302). However, in view of security and information protection, it is not desirable to compare pieces of information managed separately in the tenant-specific device information storage units 402 in a single storage unit where the pieces of information are not securely separated. In the present exemplary embodiment, a representative data conversion unit 403 tallies for each customer some of the pieces of device information stored in tenant units in the tenant-specific device information storage units 402. Then, the representative data conversion unit 403 excludes confidential information and personal information from the tallied information, and then converts the tallied information into representative data (device information representative data 405) with which the operational statuses of device information of the customers can be compared. In this way, data of a customer can be compared with those of other customers while security is ensured.

Examples of a method for excluding confidential information and personal information will be described below. For example, as to stable operation rate information that indicates the percentage of stable operation of a device, instead of the performance value of the stable operation rate, information about whether a predetermined target value of each customer is satisfied is converted into representative data. Use of such representative data makes it possible to compare priority levels of the customers (e.g., attention needs to be paid to a customer that does not satisfy the target value) while security and information protection are ensured. The device information representative data 405 is not limited to the foregoing example.

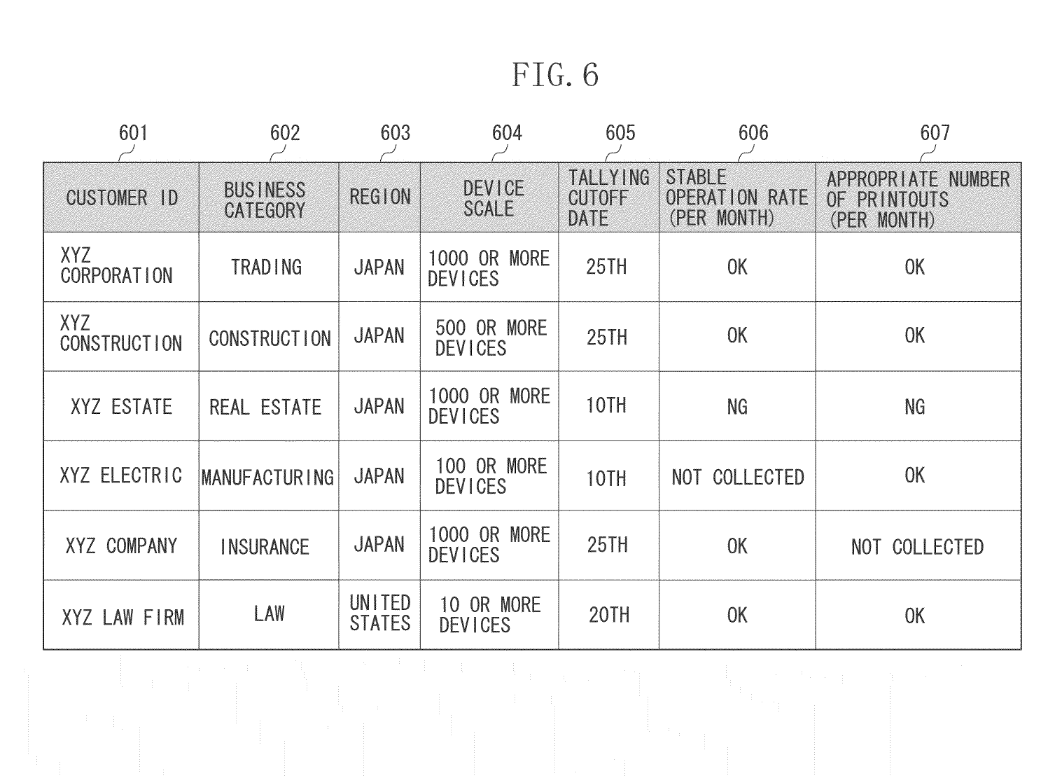

A storage unit 404 is configured to store information other than the device information. The storage unit 404 stores the device information representative data 405 and operator attention information 406. The device information representative data 405 is generated by tallying in group units (herein, in customer units) some of the pieces of device information of a plurality of tenants managed by the tenant-specific device information storage units 402, and then hiding or excluding a portion of the tallied operational information. Details thereof will be described below with reference to FIG. 6.

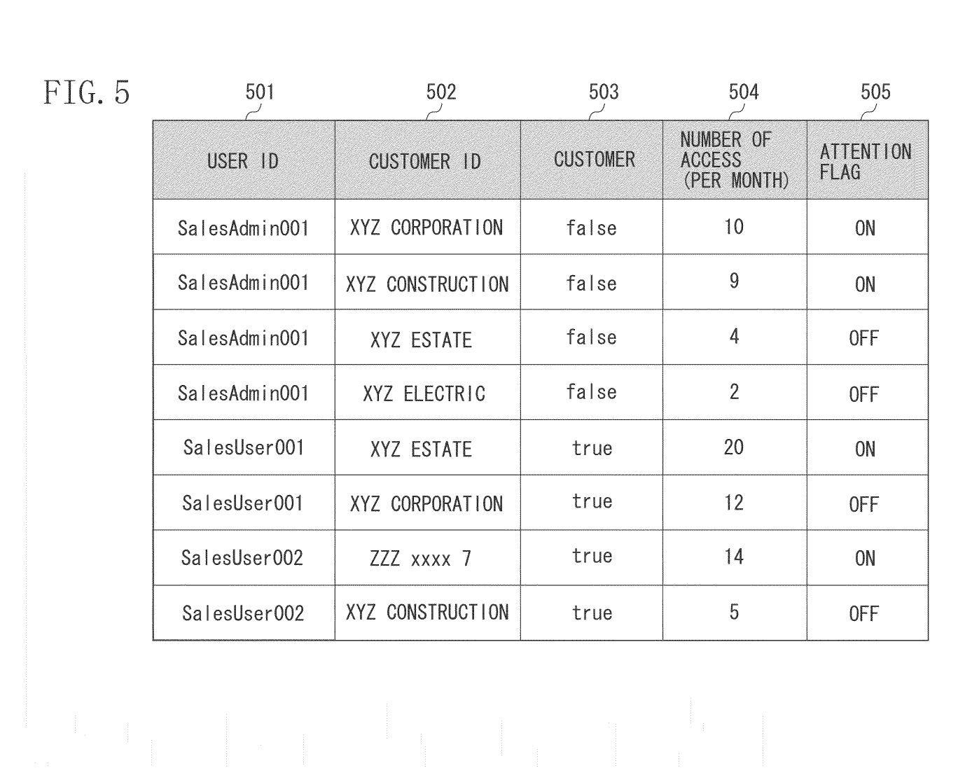

The operator attention information 406 is information that indicates a customer on which an operator as a service provider focuses. Details of the operator attention information 406 will be described below with reference to FIG. 5. Possible factors that make a service provider to focus on a particular customer are that the service provider is in charge of the operation of the customer, that the profit from the customer is large, etc. Use of the operator attention information 406 makes it possible to determine a customer on which the service provider focuses. The storage unit 404 is provided separately from the tenant-specific device information storage units 402, which store information separately in tenant units, so as to store information for providing display services illustrated in FIGS. 7 and 8 described below.

A display priority determination unit 407 determines the priority order of a customer to be displayed based on the device information representative data 405 and the operator attention information 406 when the display priority determination unit 407 receives a device information display request from the client terminal 104. The display priority determination unit 407 uses the device information representative data 405 to discriminate a customer that requires more attention, and the display priority determination unit 407 sets higher priority to the customer. The display priority determination unit 407 also uses the operator attention information 406 to set higher priority to a customer on which the service provider focuses. By use of the two types of information in the determination, the display priority determination unit 407 can dynamically determine a customer that the service provider desires to see preferentially.

A display information sending unit 408 sequentially acquires the device information from the tenant-specific device information storage units 402 according to the priority order determined by the display priority determination unit 407, and sends the acquired device information to the client terminal 104. Alternatively, the display information sending unit 408 may tally in customer units the device information acquired from the tenant-specific device information storage units 402, and then send the tallied information to the client terminal 104. Further, the display information sending unit 408 may acquire the information tallied in customer units from the device information representative data 405 in the storage unit 404 in the priority order determined by the display priority determination unit 407, and send the acquired information to the client terminal 104. In a case where the information in customer units is sent from the device information representative data 405, the information from which personal information is hidden or excluded is sent. Therefore, the security of data provided to the user is ensured. Further, the information to be sent may be selected via a user authority, settings, and the like from the information from which personal information is excluded and the information from which personal information is not excluded.

A program for realizing the function of the software configuration of the device management server 101 illustrated in FIG. 4 is stored in the hard disk 303 of the device management server 101, and the CPU 301 of the device management server 101 loads the program into the memory 302 and executes the program to realize the function.

The function of the device management server 101 may be realized by a single server or a management system including one or more servers. In a case where the function of the device management server 101 is realized by a management system including one or more servers, the function of the device management server 101 may be realized by one or more storage servers configured to store collected data, one or more management servers configured to provide management functions for providing a web UI, and the like.

Next, the software configuration of the client terminal 104 will be described.

A display unit 440 displays display information received from the device management server 101. In a case where the display information is sequentially sent, the display unit 440 can sequentially display the received display information so that the display information received first is displayed first. The display unit 440 receives and displays the information sequentially in descending order of priority determined by the device management server 101, whereby the display unit 440 can display the information sequentially so that the information that the service provider desires to see the most is displayed first. A program for realizing the function of the display unit 440 is stored in the hard disk 303 of the client terminal 104, and the CPU 301 of the client terminal 104 loads the program into the memory 302 and executes the program to realize the function of the display unit 440.

FIG. 5 illustrates an example of the data configuration of the operator attention information 406 managed by the storage unit 404 of the device management server 101.

A user ID 501 is information for identifying an operator who is accessing the device management server 101. A customer ID 502 is information for identifying a customer managed by the device management server 101. In the present exemplary embodiment, attention degree information of a same customer can be stored for each operator. For example, the customer “XYZ Corporation” can be managed in such a manner that the operator “SalesAdmin001” has a high degree of attention with respect to the customer “XYZ Corporation,” whereas the operator “SalesUser001” does not have a high degree of attention.

Customer information 503 is information for determining for each customer whether the operator is in charge of the customer. The operator selects a customer of the operator on a person-in-charge setting screen (not illustrated). For a customer of which the operator is in charge, “true” is stored in the customer information 503. For a customer of which the operator is not in charge, “false” is stored in the customer information 503. The display priority determination unit 407 determines that a customer has a higher degree of attention of the operator and, thus, has higher display priority if the operator is in charge of the customer.

Number-of-access (per month) information 504 is information that indicates how many times the operator accesses the customer per unit period. The display priority determination unit 407 determines that a customer with a greater number of accesses has a higher degree of attention of the operator and, thus, has higher display priority.

An attention flag information 505 is information indicating that the operator focuses on the customer. The operator sets an attention flag 709, which will be described below with reference to FIG. 7, to a customer so that the customer is explicitly set as a focused customer. The display priority determination unit 407 determines that a customer to which the attention flag is set (customer with the attention flag “ON”) has a higher degree of attention of the operator and, thus, has higher display priority.

When the display priority determination unit 407 receives an operational status display request, the display priority determination unit 407 comprehensively ranks the degree of attention of the identified operator based on the customer information 503, the number-of-access (per month) information 504, and the attention flag information 505 to determine the display priority order. An algorithm for the ranking is not particularly limited. The weighting of the parameters of the customer information 503, the number-of-access (per month) information 504, and the attention flag information 505 in the ranking may be set via a setting screen (not illustrated) or may be optimized by a genetic algorithm for each operator.

FIG. 6 illustrates an example of the data configuration of the device information representative data 405 managed by the storage unit 404 of the device management server 101.

A customer ID 601 is information for identifying a customer managed by the device management server 101. A business category 602 is information that indicates the business category of a customer. The business category 602 is set via a customer information registration screen (not illustrated). A region 603 is information that indicates a region of a customer. The region 603 is also set via the customer information registration screen (not illustrated). A device scale 604 is information that indicates a scale of the number of image forming apparatuses 102 owned by the customer. In the device management service, features of the appropriate number of printouts and the stable operation rate vary depending on the business category, the region, and the scale of the number of devices of the customer. Thus, the information about the business category, the region, the scale of the number of devices, and the like of the customer is used as search conditions to narrow down the customers to be compared when the operational statuses of the customers are displayed and compared, which will be described below with reference to FIG. 8.

A tallying cutoff date 605 indicates a cutoff date for the tallying of the device information collected from the image forming apparatuses 102 as the operational status. The display priority determination unit 407 also uses the tallying cutoff date 605 in determining the priority order. For example, as to the customers with a stable operation rate (per month) 606 set to “NG,” the customer with the tallying cutoff date 605 closer to the current date is determined to have higher priority, since the remaining time for improving the operational status is shorter. The stable operation rate is calculated by calculating from the collected device information an inoperable period during which the image forming apparatus 102 cannot be used due to an error or the like, and then calculating the expression “(business hours of the customer−inoperable period)/business hours of the customer.” In this way, the percentage of the period during which the image forming apparatus 102 could be used stably during the business hours of the customer can be checked.

The stable operation rate (per month) 606 is information that indicates whether the percentage of the stable operation of the image forming apparatus 102 satisfies the target value set for each customer. In a case where the target value is satisfied, “OK” is stored. On the other hand, in a case where the target value is not satisfied, “NG” is stored. The tenant-specific device information storage unit 402 stores the numerical value (%) of the stable operation rate, the numerical value of the stable operation rate of each image forming apparatus 102, or the numerical value of the stable operation rate of the customers on a group-basis. Since the foregoing information contains confidential information of the customers, the representative data conversion unit 403 converts the information into information about whether each customer satisfies the target value and then stores the converted information in the stable operation rate (per month) 606. Although not illustrated, the stable operation rate (per month) stores information concerning the past several months. The unit of tallying is not limited to the monthly basis and may be a quarterly basis, weekly basis, daily basis, or the like. The display priority determination unit 407 determines that a customer with the stable operation rate (per month) 606 set to “NG” has higher display priority, since the operational status of such a customer requires attention and improvement. The display priority determination unit 407 also determines that a customer such as “XYZ Electric” for which no device information for calculating the stable operation rate (per month) is collected (customer for which the stable operation rate (per month) 606 stores “not collected”) has high display priority, since such a customer requires attention.

An appropriate number of printouts is information that indicates whether the use of the image forming apparatus 102 is in an appropriate state based on whether, from the collected device information, an average number of printouts of each image forming apparatus 102 is within a range defined by lower and upper limits of printouts that are preset for each image forming apparatus 102. In a case where the average number of printouts is smaller than the lower limit of printouts, the image forming apparatus is determined not to have been used and is set to “Under.” On the other hand, in a case where the average number of printouts is larger than the upper limit of printouts, the image forming apparatus 102 is determined to have been excessively used and is set to “Over.” The service provider is required to increase the number of image forming apparatuses 102 that are in an appropriate state by changing the locations of the image forming apparatuses 102 set to “Under” or “Over.”

Appropriate-number-of-printouts (per month) information 607 indicates whether the percentage of the image forming apparatuses 102 determined to have an appropriate average number of printouts satisfies a target value set for each customer. In a case where the percentage satisfies the target value, “OK” is stored. On the other hand, in a case where the percentage does not satisfy the target value, “NG” is stored. As in the case of the stable operation rate, specific numerical values of the appropriate number of printouts and values for each image forming apparatus 102 are stored in the tenant-specific device information storage unit 402, and the representative data conversion unit 403 converts the information into information that indicates whether an average value is in an appropriate state and then stores the converted information in the appropriate-number-of-printouts (per month) information 607. The appropriate-number-of-printouts (per month) information 607 also stores information concerning the past several months, and the unit of tallying is not limited to the monthly basis. The display priority determination unit 407 determines that a customer with the appropriate-number-of-printouts (per month) information 607 set to “NG” or a customer having no device information collected for calculating the appropriate number of printouts (per month) (customer set to “not collected”) has high display priority, since the operational status of such a customer requires attention and improvement. Either one of the customer set to “NG” and the customer set to “not collected” may be determined to have higher display priority.

When the display priority determination unit 407 receives an operational status display request, the display priority determination unit 407 comprehensively ranks the degree of attention of the identified operator with respect to a destination customer based on the tallying cutoff date 605, the stable operation rate (per month) 606, and the appropriate-number-of-printouts (per month) information 607 and then determines the display priority. The priority order can be set not only for each customer but also for each stable operation rate or each appropriate number of printouts. For example, “XYZ Electric” is determined to have high display priority since the stable operation rate (per month) 606 is “not collected,” while “XYZ Electric” is determined to have low display priority since the appropriate-number-of-printouts (per month) information 607 is set to “OK.” An algorithm for ranking is not limited as in the case of the operator attention information 406. Further, the type of the device information representative data 405 is not limited to the stable operation rate, and the appropriate number of printouts and may be any other operational status data that can be calculated from the device information.

FIG. 7 illustrates an example of a list screen of operational statuses of respective customers displayed on the display unit 440 of the client terminal 104 when the client terminal 104 receives display information from the device management server 101. This screen is used to display a list of the operational statuses of the customers to which the service provider provides the service, and the service provider checks whether there is any problem in the operational statuses.

An operator display section 701 is an area for displaying information about the operator as the service provider. The operator display section 701 outputs the ID of the operator specified via an authentication screen (not illustrated). A focused customer display section 702 is an area for displaying a customer on which the operator focuses The focused customer display section 702 displays information of the customers determined as having high display priority by the display priority determination unit 407 of the device management server 101 based on the operator attention information 406 focused.

An operational status display section 703 is an area for displaying the operational status of an individual customer. While the operational status display section 703 displays the customer name, the stable operation rate of the device, and the appropriate number of printouts of the device in the present exemplary embodiment, items to be displayed are not limited thereto.

An attention flag 709 is a flag with which the operator explicitly designates a customer to be focused on. The attention flag 709 is enabled so that the attention flag information 505 of the operator attention information 406 is set to “ON.”

An information-being-acquired symbol 704 is a symbol indicating a state that information is being acquired from the device management server 101. The type of the symbol to be displayed is not limited thereto, and the priority order determined by the device management server 101 may be displayed.

An attention-needed customer display section 705 is an area for displaying a customer that requires attention to the operation. The attention-needed customer display section 705 displays information of a customer determined to have high display priority by the display priority determination unit 407 of the device management server 101 based on the device information representative data 405.

A warning comment display section 706 is an area for displaying a reason why the display priority determination unit 407 determines that attention is required. In the example of “XYZ Estate,” the comment “Tallied value is lower than target value” is displayed as an example of a message warning that the tallied value of the device information is lower than the operational target value. In the example of “XYZ Electric,” the comment “Tallied value for measurement of the stable operation rate has not been collected for ten or more days” is displayed as an example of a message warning that device information indicating the environment of the customer has not been received for a certain period.

A normal customer display section 707 is an area for displaying the operational status of a customer determined not to have high display priority by the display priority determination unit 407 of the device management server 101.

As illustrated in FIG. 7, the customers are sequentially displayed in descending manner from the customer determined to have the higher priority order, whereby the operator can promptly see the operational status of a customer to be focused on, and then the operational statuses of other customers. Further, the priority order is determined using both the operator attention information 406 and the device information representative data 405 so that the customers can be displayed in the comprehensively-determined priority order based on the focused customers of the operator and the customers that require attention to the operation although the operator does not focus on the customers.

As described above, the list screen of the operational statuses of the respective customers illustrated in FIG. 7 is for displaying an overview of operational information of each group that is tallied in group units (in customer units in the present exemplary embodiment). The list screen of the operational statuses of the respective customers illustrated in FIG. 7 preferentially provides information of a group (focused customers) with a higher degree of attention according to indexes of the degree of attention such as the customer information 503, the number-of-access (per month) information 504, and the attention flag information 505. Further, the list screen of the operational statuses of the respective customers preferentially provides information of a group that shows an abnormal tallied value (attention-needed customers) of the stable operation rate (per month) 606, the appropriate-number-of-printouts (per month) information 607, etc.

FIG. 8 illustrates an example of a comparison display screen used to compare the operational status of the focused customer with the operational statuses of other customers displayed on the display unit 440 of the client terminal 104 when the client terminal 104 receives display information from the device management server 101. This screen is used to display and compare the customers with favorable or unfavorable operational statuses among the customers having similar conditions to those of the focused customer so that the service provider can improve the operational status of the specific customer.

A focused customer display section 801 is an area for displaying one customer on which the operator focuses. The focused customer display section 801 displays information of a specific customer selected and designated via a focused customer selection screen (not illustrated) as a focused customer. A customer stored in session information or cookie information may be determined to be the focused customer. Further, the focused customer display section 801 may display a customer that is determined to have high display priority by the display priority determination unit 407 of the device management server 101 based on the operator attention information 406.

An operational status display section 802, similar to the operational status display section 703, is an area for displaying the operational status of a customer.

A search condition designating section 803 is for designating conditions used in searching a customer having similar conditions to those of the focused customer. In this screen example, the search condition can be selected from the region, the business category, the device scale, and the cutoff date that indicates the cutoff for monthly tallying, of the customer. In the example illustrated in FIG. 8, the search condition is set to search for customers with favorable and unfavorable operational statuses among the customers that are similar in “region” and “device scale” of the customers to the focused customer “XYZ Estate.” The items of the condition are not limited to those described above.

A favorable-operation customer display section 804 is an area for displaying the customers with favorable operation among the customers similar to the focused customer in search conditions. The favorable-operation customer display section 804 displays information of the customers determined to have high display priority by the display priority determination unit 407 of the device management server 101 based on the device information representative data 405 of the narrowed-down customers. The display priority determination unit 407 determines the customers to be displayed in the favorable-operation customer display section 804 in such a manner that a customer with more favorable operation has higher priority order. For example, the display priority determination unit 407 determines that a customer with the stable operation rate (per month) 606 or the appropriate-number-of printouts (per month) information 607 set to “OK” has higher display priority since the operational status of such a customer is favorable.

An unfavorable-operation customer display section 805 is an area for displaying a customer with unfavorable operation among the customers similar to the focused customer in search conditions. The unfavorable-operation customer display section 805 displays information of a customer determined as having high display priority by the display priority determination unit 407 of the device management server 101 based on the device information representative data 405 of the narrowed-down customers. The display priority determination unit 407 determines the customers to be displayed in the unfavorable-operation customer display section 805 so that a customer with more unfavorable operation has higher priority order. For example, the display priority determination unit 407 determines that a customer with the stable operation rate (per month) 606 or the appropriate-number-of-printouts (per month) information 607 set to “NG” has higher display priority since the operational status of such a customer is unfavorable.

The customers with a favorable operational status that are displayed in the favorable-operation customer display section 804 and the customers with an unfavorable operational status that are displayed in the unfavorable-operation customer display section 805 are displayed and compared with the focused customer displayed in the focused customer display section 801, so that the operator can effectively improve the operations of the focused customer and the customers with unfavorable operation. Further, when the display priority determination unit 407 compares the focused customer with a customer to be compared, if a period of time that has elapsed since the previous tallying cutoff date of the customer to be compared is short, the display priority determination unit 407 compares the device information representative data 405 of the previous month instead of the device information representative data 405 of the present month, since the credibility of the device information representative data 405 is low in a case where the period of time that has elapsed since the tallying cutoff date is short. Use of the device information representative data 405 with higher credibility enables provision of effective comparison information.

The focused customer comparison display screen illustrated in FIG. 8 is for displaying and comparing the operational information of each group that is tallied in group units (in customer units in the present exemplary embodiment). The focused customer comparison display screen illustrated in FIG. 8 preferentially provides information of a group having similar features of conditions such as the business category 602, the region 603, the device scale 604, and the tallying cutoff date 605.

The client terminal 104 sequentially acquires information from the device management server 101 and displays the acquired information sequentially in the order of acquisition. There are several methods therefor. One of the methods is a method in which the display unit 440 of the client terminal 104 executes a script such as the Java® script to realize the foregoing.

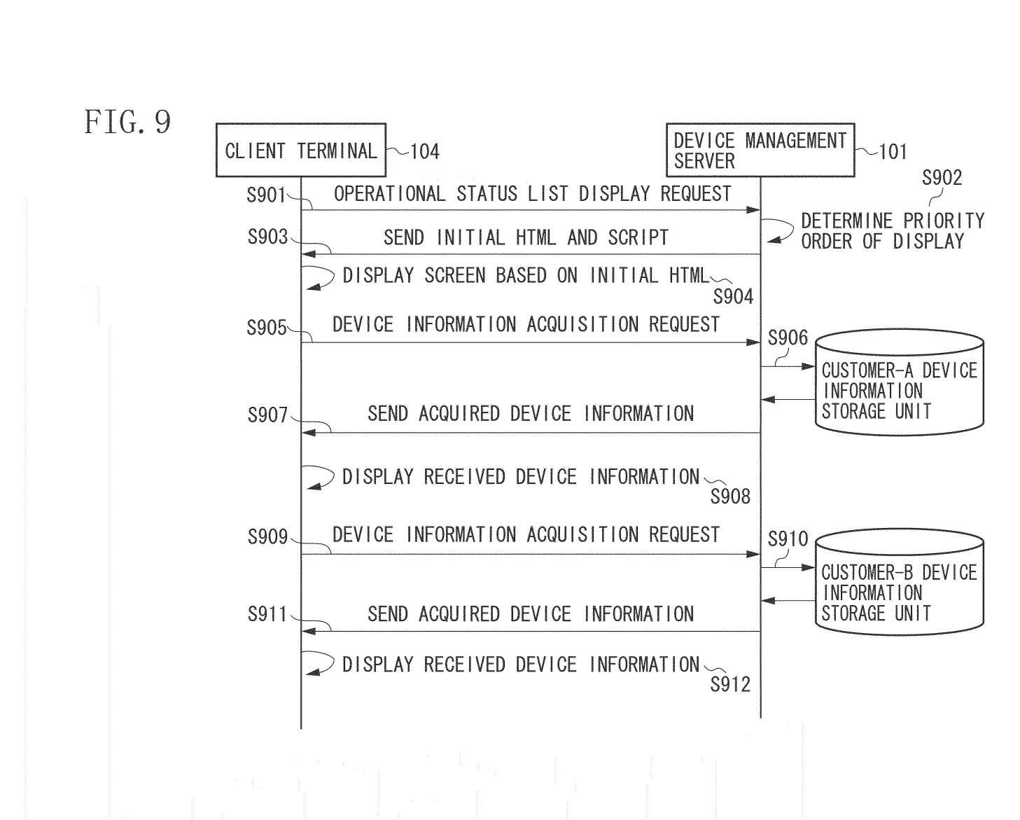

FIG. 9 is a process sequence diagram between the client terminal 104 and the device management server 101 when a scrip is executed to sequentially display on the client terminal 104 the list screen of the operational statuses for each customer or the comparison display screen for comparing the operational statuses of a customer with the operational status of the focused customer. The CPU 301 of the device management server 101 and the CPU 301 of the client terminal 104 respectively execute the programs in the software configuration illustrated in FIG. 4 to realize the following processing.

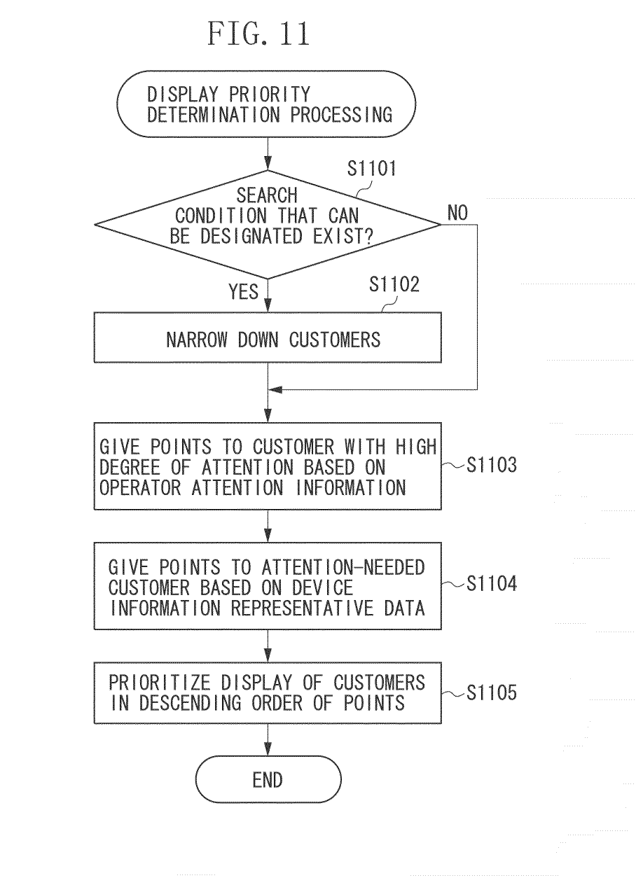

In step S901, the display unit 440 of the client terminal 104 sends an operational status list display request (request for displaying the operational status list screen illustrated in FIG. 7 or the operational status comparison screen illustrated in FIG. 8 for the comparison with the focused customer) to the device management server 101. In step S902, in response to the list display request, the display priority determination unit 407 of the device management server 101 determines a priority order of information and customers to be displayed. Details of step S902 will be described below with reference to FIG. 11.

In step S903, the display priority determination unit 407 of the device management server 101 sends the client terminal 104 a request for acquiring device information according to the priority order determined in step S902 and initial Hypertext Markup Language (HTML). A screen is displayed based on the initial HTML.

The initial HTML refers to a previous screen of FIG. 7 or 8 where no graph is displayed. In step S904, the display unit 440 of the client terminal 104 displays a screen based on the initial HTML. At this time, the information-being-acquired symbol 704 is displayed in place of a graph that is not yet displayed.

In step S905, the display unit 440 of the client terminal 104 executes the script received in step S903 and sends a device information acquisition request to the device management server 101 according to the display priority order determined in step S902.

In step S906, the display information sending unit 408 of the device management server 101 acquires from the tenant-specific device information storage unit 402 the device information of the customer designated by the acquisition request. In step S907, the display information sending unit 408 sends the client terminal 104 the device information acquired in step S906. The display information sending unit 408 may tally in group units the device information acquired from the tenant-specific device information storage unit 402, and then sends the tallied device information to the client terminal 104. Alternatively, in step S906, the display information sending unit 408 may acquire from the device information representative data 405 information tallied on a per-customer basis as the device information of the customer designated by the acquisition request and, in step S907, the display information sending unit 408 may send the tallied information to the client terminal 104.

In step S908, the display unit 440 of the client terminal 104 displays (draws) in the operational status display section 703 or 802 the device information received from the device management server 101.

In steps S909 to S912, as in steps S905 to S908, the client terminal 104 acquires the device information from the device management server 101 according to the display priority order determined in step S902, and displays the acquired information on the display unit 440. Processing similar to the foregoing processing is repeated, and when information of all the customers to be displayed is displayed, the process sequence is ended. While the device information acquisition requests are serially processed in the present exemplary embodiment, steps S905 and S911 may be executed parallel to shorten the entire display time.

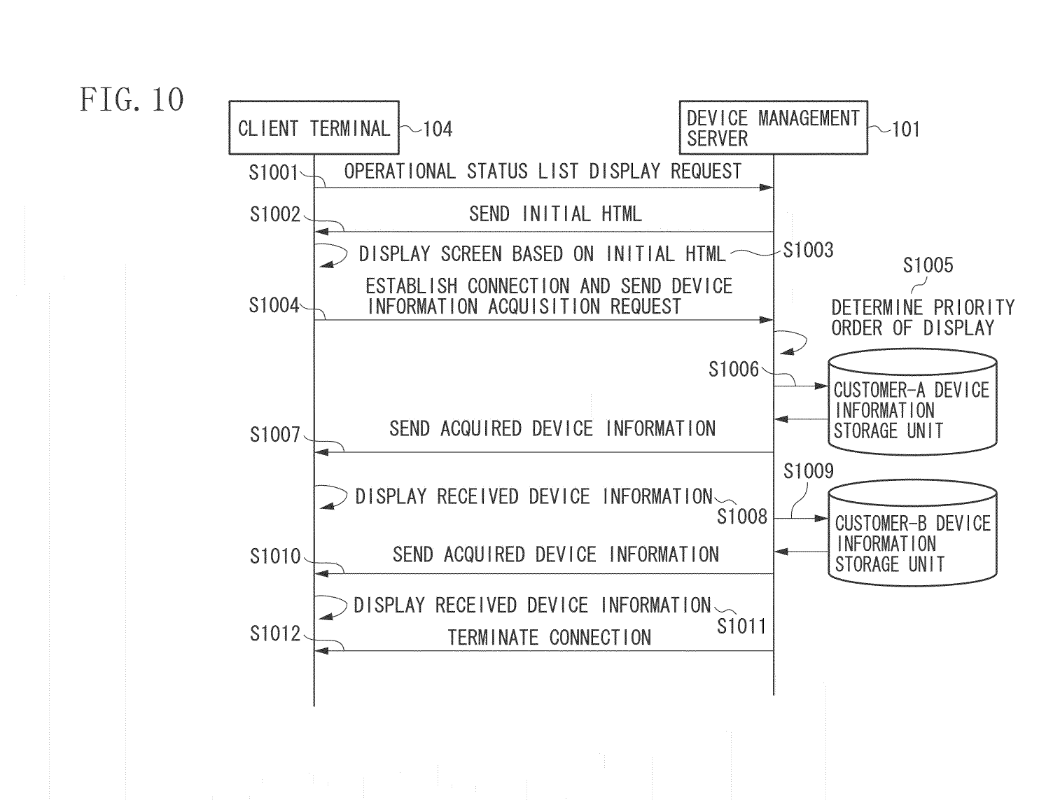

Another method for the sequential display is a method in which the device management server 101 pushes the device information to realize the sequential display, e.g., WebSocket. Details thereof are described below with reference to FIG. 10.

FIG. 10 is a process sequence diagram between the client terminal 104 and the device management server 101 when the device management server 101 pushes the device information to sequentially display the list screen of the operational statuses of the customers or the comparison display screen for comparing the operational statuses of customers with the operational status of the focused customer. The CPU 301 of the device management server 101 and the CPU 301 of the client terminal 104 respectively execute programs in the software configuration illustrated in FIG. 4 to realize the following processing.

In step S1001, the display unit 440 of the client terminal 104 sends the device management server 101 an operational status list display request (request for displaying the operational status list screen illustrated in FIG. 7 or the operational status comparison screen illustrated in FIG. 8 for the comparison with the focused customer). In step S1002, the device management server 101 sends the client terminal 104 the initial HTML illustrated in FIG. 9 in response to the display request.

In step S1003, the display unit 440 of the client terminal 104 displays a screen based on the initial HTML. In step S1004, the client terminal 104 establishes a connection to the device management server 101 and sends a device information acquisition request.

In step S1005, in response to the acquisition request, the display priority determination unit 407 of the device management server 101 determines the priority order of information and customers to be displayed. Details of step S1005 will be described below with reference to FIG. 11.

In step S1006, the device management server 101 acquires from the tenant-specific device information storage unit 402 the device information of a customer with high priority order. In step S1007, the display information sending unit 408 sends the acquired device information to the client terminal 104. The display information sending unit 408 may tally in group units the device information acquired from the tenant-specific device information storage unit 402, and then sends the tallied device information to the client terminal 104. Alternatively, in step S1006, the display information sending unit 408 may acquire from the device information representative data 405 information tallied on a per-customer basis as the device information of the customer designated by the acquisition request and, in step S1007, the display information sending unit 408 may send the tallied information to the client terminal 104.

In step S1008, the display unit 440 of the client terminal 104 displays (draws) in the operational status display section 703 or 802 the device information received from the device management server 101.

In steps S1009 to S1011, as in steps S1006 to S1008, the device management server 101 acquires the device information according to the display priority order determined in step S1005, and then sends the acquired information to the client terminal 104. Processing similar to the foregoing processing is repeated until information of all the customers to be displayed is sent. In step S1012, the device management server 101 terminates the connection, and the process sequence is ended. While the device information acquisition requests are serially processed in the present exemplary embodiment, steps S1006 and S1009 may be executed parallel to shorten the entire display time.

While, in the present exemplary embodiment, the methods has been described with reference to FIGS. 9 and 10 in which the client terminal 104 sequentially acquires the information from the device management server 101 and sequentially displays the acquired information so that the acquired information is displayed in the acquired order, the methods are not limited to the two methods described above.

FIG. 11 is a flow chart illustrating an example of a process executed by the display priority determination unit 407 of the device management server 101 to determine the display priority order of the customers in step S902 in FIG. 9 or in step S1005 in FIG. 10. The CPU 301 of the device management server 101 executes programs in the software configuration of the device management server 101 illustrated in FIG. 4 to realize the following processing.

In step S1101, the display priority determination unit 407 determines whether the operational status list acquisition request (request for displaying the operational status list screen illustrated in FIG. 7 or the operational status comparison screen illustrated in FIG. 8 for the comparison with the focused customer) contains a search condition that can be designated via the search condition designating section 803 in FIG. 8. In a case where the display priority determination unit 407 determines that the operational status list acquisition request contains such a search condition (YES in step S1101), then in step S1102, the display priority determination unit 407 narrows down the customers that match the search conditions based on the device information representative data 405, and then the processing proceeds to step S1103. On the other hand, in a case where the display priority determination unit 407 determines that the operational status list acquisition request does not contain such a search condition (NO in step S1101), the processing directly proceeds to step S1103.

In step S1103, the display priority determination unit 407 gives points to customers having a high degree of attention based on the user ID that has made the operational status list acquisition request and the operator attention information 406. For example, five points are given to a customer of the user, five points to one point are given to customers in descending order of the number of access, and five points are given to a customer with the attention flag. Then, the total points are compared.

In step S1104, the display priority determination unit 407 gives points to customers that require attention based on the device information representative data 405. For example, as to the stable operation rate (per month) 606 and the appropriate-number-of-printouts (per month) information 607, five points are given to “NG,” three points are given to “not collected,” and zero is given to “OK.” Further, the foregoing points are multiplied by 1 if the number of days until the next tallying cutoff date is less than five days, 0.8 if the number of days is five or more and less than ten days, and 0.5 if the number of days is ten or more days, and then the resulting points of the customers are compared. In this way, the period until the next tallying cutoff date can be taken into consideration in giving points to the customers that require attention.

In step S1105, the display priority determination unit 407 sums the points given in steps S1103 and S1104 and compares the sums to prioritize the customers in descending order of the points. A method for giving the points is not limited to the foregoing method.

As described above, the management system can dynamically determine the display priority order of the customers according to a situation displayed on the web UI by the service provider (e.g., operator or service person of sales company) and the information of the customers is displayed from that of the customer with higher priority in descending order on the web UI. Furthermore, the display priority order of the customers is determined by comparing the data from which personal information is hidden or excluded, so that security of the collected data can be ensured. Therefore, a confirmation screen including the limited device operational status of the focused customer of the service provider, the customers that require attention, the customers having a similarity to a particular customer, and the like can timely be provided to the service provider while security is ensured.

In the exemplary embodiments described above, the configuration in which the display information sending unit 408 of the device management server 101 sends the client terminal 104 the customer information according to the priority order, and the client terminal 104 displays the information in the order of reception. Alternatively, the display information sending unit 408 of the device management server 101 may create a display screen on which the customer information is arranged in the priority order and then send the created display screen to the client terminal 104, and the client terminal 104 may receive and display the display screen on which the customer information is arranged in the priority order.

It should be apparent that the foregoing configurations and details of various types of data are not intended to limit the configurations and details of the data and can be changed or modified according to an intended use.

While the foregoing describes exemplary embodiments, the present disclosure can be implemented to, for example, a system, an apparatus, a method, a program, a storage medium, etc. Specifically, the present disclosure is applicable to a system including a plurality of devices or an apparatus including a single device.

Further, any combinations of the features of the exemplary embodiments described above are also encompassed within the scope of the disclosure.

### Other Embodiments

Additional embodiments can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2013-244898 filed Nov. 27, 2013, which is hereby incorporated by reference herein in its entirety.

What is claimed is:

1. A management system configured to collect operational information of network devices provided on a plurality of local networks, the management system comprising:
a first management unit configured to separately manage the collected operational information in a plurality of tenants to which different access rights are set;
a second management unit configured to tally and manage in group units a part of the operational information of the plurality of tenants managed separately by the first management unit; and
a providing unit configured to provide the tallied operational information managed by the second management unit,
wherein the second management unit manages the tallied operational information so as to hide or exclude a part of the tallied operational information.

2. The management system according to claim 1, wherein the second management unit manages an attention degree index for each group, and
wherein, in a case where an overview of the tallied operational information is displayed for each group, the providing unit provides information of a group with a higher degree of attention according to the attention degree index.

3. The management system according to claim 1, wherein the providing unit provides information of a group indicating an abnormal tallied value.

4. The management system according to claim 1, wherein, in a case where the tallied operational information is displayed to be compared for each group, the providing unit provides information of a group having a similar feature.

5. The management system according to claim 4, wherein the providing unit provides information of a group having a similar feature to a feature of a designated group.

6. The management system according to claim 4, wherein the providing unit provides information of a group having a similar feature in a designated condition.

7. The management system according to claim 1, wherein, in a case where the tallied operational information is displayed for each group, the providing unit provides a message with respect to a particular group.

8. The management system according to claim 1, wherein the group is a customer to be managed by the management system.

9. The management system according to claim 1, wherein the information to be hidden or excluded is personal information.

10. A method for controlling a management system configured to collect operational information of network devices provided on a plurality of local networks, the method comprising:
separating collected operational information in a plurality of tenants to which different access rights are set and storing in a first management unit, the collected operational information;
managing as a second managing, by tallying in group units a part of the operational information of the plurality of tenants managed separately by the first management unit and storing the tallied operational information; and
providing the tallied operational information,
wherein the tallied operational information is managed so as to hide or exclude a part of the tallied operational information.
